(19) United States
(12) Patent Application Publication
(10) Pub. No.: US 2026/0280876 A1
(43) Pub. Date: Sep. 17, 2026

(54) RECOGNITION-STATE QUANTUM INFORMATIONAL ENCRYPTION (RSQIE) FOR QUANTUM-RESISTANT SECURE DIGITAL COMMUNICATION AND DATA PROTECTION

(71) Applicant: Jonathan Washburn, Austin, TX (US)

(72) Inventor: Jonathan Washburn, Austin, TX (US)

(21) Appl. No.: 19/562,605

(22) Filed: Mar. 10, 2026

Related U.S. Application Data
(60) Provisional application No. 63/770,207, filed on Mar. 11, 2025.

(51) Int. Cl. H04L 9/32; H04L 9/08

(52) U.S. Cl. CPC H04L 9/32; H04L 9/0861

(57) ABSTRACT

A recognition-state quantum informational encryption (RSQIE) system and method provide quantum-resistant secure digital communication and data protection. Digital information is encoded into recognition-coherence scalars using a recognition mapping in which a recognition scalar R is computed as R=x/(x+X_opt), where x is a positive parameter associated with a symbol and X_opt is a predetermined constant. One or more quantum states are prepared based on the recognition scalars and encrypted using an encryption transformation derived from a recognition-coupled interaction that depends on message-associated and key-associated recognition operators. A corresponding inverse transformation decrypts the encrypted representation to recover the digital information. In some embodiments, verification includes computing a coherence deviation deltaR=abs(R_expected−R_measured) and triggering a responsive action when deltaR, or a windowed statistic derived from deltaR, exceeds a threshold, thereby providing breach indication in disturbance-sensitive implementations.

### CROSS-REFERENCE TO RELATED APPLICATIONS

This application claims the benefit of U.S. Provisional Patent Application No. 63/770,207, filed Mar. 11, 2025, entitled “Recognition-State Quantum Informational Encryption (RSQIE) for Quantum-Resistant Secure Digital Communication,” the entire contents of which are incorporated herein by reference.

### BACKGROUND

The present disclosure relates generally to secure digital communication and data protection and, more particularly, to quantum-resistant encryption systems and methods that employ recognition-state quantum informational encryption (RSQIE) to encode, encrypt, decrypt, and verify information using recognition-coherence mappings and quantum-state operations.

Digital communication networks and data storage systems commonly rely on cryptographic mechanisms whose security is premised on the computational difficulty of certain mathematical problems. Classical public-key schemes, including RSA and elliptic-curve cryptography, rely on assumptions related to integer factorization and discrete logarithms. These assumptions are threatened by the prospect of scalable quantum computation, which may enable polynomial-time attacks on such schemes, thereby increasing risk to data in transit and data at rest.

Post-quantum cryptographic schemes have been developed to mitigate quantum threats; however, many such schemes involve tradeoffs in bandwidth, key size, and computational overhead, and generally do not provide physical-layer tamper indication. Quantum key distribution (QKD) can provide information-theoretic key establishment in certain channel models, but typically focuses on key exchange rather than direct encryption of arbitrary payloads and may be limited by deployment complexity, channel loss, and implementation-specific vulnerabilities.

Accordingly, there remains a need for cryptographic systems and methods that provide quantum-resistant secure communication and data protection, including embodiments that support direct encryption of information and embodiments that can detect or indicate interception or tampering through measurable deviations in recognition-coherence parameters.

### SUMMARY

The present disclosure provides recognition-state quantum informational encryption (RSQIE) systems and methods for quantum-resistant secure digital communication and data protection. In various embodiments, binary or multi-level digital information is encoded into recognition-coherence scalars derived from a recognition mapping, and corresponding quantum states are prepared and transformed by an encryption operation defined by a recognition-coupled interaction.

A corresponding decryption operation reverses the encryption to recover the original information. In some embodiments, the system further computes a coherence deviation metric that indicates mismatch between expected and measured recognition values, thereby providing breach indication in disturbance-sensitive implementations.

In one embodiment, a method includes encoding digital symbols into recognition scalars R_b computed as R_b=x_b/(x_b+X_opt), where x_b is a positive symbol-associated parameter and X_opt is a predetermined constant. The method further includes generating or provisioning a recognition key, applying an encryption transformation to produce an encrypted quantum state for transmission or storage, applying an inverse transformation to decrypt, and reconstructing the digital symbols based on measurement outcomes.

In some embodiments, the encryption transformation is implemented as a unitary operator U_crypto derived from a recognition-coupled Hamiltonian H crypto, and decryption is implemented as an inverse operation U_crypto\hat{ }{−1}. In some embodiments, breach detection is implemented by computing a coherence deviation deltaR=abs(R_expected−R_measured) and comparing deltaR to a threshold.

In another embodiment, an apparatus includes a recognition encoder configured to generate recognition scalars and prepare corresponding quantum states, a key generation or key provisioning module, an encryption module configured to apply an encryption operation to the prepared states, a decryption module configured to apply an inverse operation, and a verification module configured to compute a coherence deviation metric and trigger one or more responsive actions when the metric satisfies a trigger condition.

In another embodiment, a non-transitory computer-readable medium stores instructions that, when executed by one or more processors, cause performance of operations including recognition-based encoding, key generation or provisioning, encryption, decryption, and verification as described herein.

### BRIEF DESCRIPTION OF THE DRAWINGS

FIG. 1 is a block diagram illustrating an example end-to-end recognition-state quantum informational encryption (RSQIE) system architecture including encoding, key generation, encryption, transmission or storage, decryption, and verification.

FIG. 2 illustrates an example recognition-based encoding in which digital symbols are mapped to recognition-coherence scalars using a recognition mapping and are represented as corresponding quantum states.

FIG. 3 illustrates an example encryption and decryption operation implemented using a recognition-coupled interaction and a reversible transformation.

FIG. 4 illustrates an example verification pipeline that computes a coherence deviation metric between expected and measured recognition values and triggers a breach indication in supported embodiments.

FIG. 5 illustrates an example recognition-key structure and corresponding key space scaling as a function of key length and alphabet size.

FIG. 6 illustrates an example no-cloning constraint model in which first and second unknown quantum input states 602 and 604 are applied to a hypothetical cloning operation 606 that outputs first and second purported clones 608 and 610, thereby supporting disturbance-sensitive interception detection in certain embodiments.

### DETAILED DESCRIPTION

The following description is presented to enable one of ordinary skill in the art to make and use the disclosed systems and methods and is provided in the context of particular embodiments and examples. Various modifications to the disclosed embodiments will be readily apparent, and the general principles described herein may be applied to other embodiments without departing from the spirit and scope of the invention. Accordingly, the present disclosure is not intended to be limited to the embodiments shown, but is to be accorded the widest scope consistent with the principles and features disclosed herein.

As used herein, the term “recognition-state quantum informational encryption” (RSQIE) refers to encryption, decryption, and verification operations in which digital information is mapped to one or more recognition-coherence values and represented using corresponding quantum states, and in which an encryption operation is performed using a recognition-coupled interaction with a recognition key. In various embodiments, an RSQIE system provides quantum-resistant secure communication and data protection for data in transit and/or data at rest.

As used herein, a “recognition scalar” or “recognition-coherence scalar” R is a real-valued quantity derived from a positive parameter x using a recognition mapping that includes a predetermined constant X_opt. In one embodiment, the recognition mapping is expressed as follows: R_hat(x)=x/(x+X_opt), where x is a positive parameter (x>0) and X_opt is a positive constant. In some embodiments, X_opt is set to X_opt=phi/pi.

“As used herein, ‘phi’ refers to the golden ratio and ‘pi’ refers to the circular constant. In embodiments that express X_opt=phi/pi, X_opt is a predetermined positive constant.”

In some embodiments, the recognition mapping is strictly increasing for x>0, which permits distinct symbol parameters to map to distinct recognition scalars. In particular, when x0 and x1 are distinct positive values associated with different symbols (e.g., bit “0” and bit “1”), the corresponding recognition scalars R0 and R1 are distinct. In one embodiment, R0=x0/(x0+X_opt) and R1=x1/(x1+X_opt), and when x0 !=x1, it follows that R0 !=R1.

In some embodiments, the recognition mapping is invertible for x>0, such that a measured recognition scalar can be used to infer a corresponding x value. In one embodiment, when R is in the interval [0, 1), the inverse mapping is given by x=(X_opt*R)/(1−R). In this manner, an RSQIE receiver may estimate an underlying symbol-associated parameter x from an estimated recognition scalar R, including in embodiments where decoding uses a threshold decision or a likelihood decision based on an expected symbol set.

As used herein, a “recognition state” refers to a quantum state prepared to represent, encode, or otherwise correspond to a recognition scalar. In various embodiments, a recognition state may be a qubit state, a multi-level qudit state, an ensemble of identically prepared states, a photonic polarization state, a time-bin state, a frequency-bin state, a continuous-variable coherent state, or another quantum state in which one or more observable quantities are deterministically related to the recognition scalar. The particular physical mapping between a recognition scalar and a quantum state may vary by implementation and does not limit the present disclosure.

In one embodiment, a message comprises a sequence of N symbols, such as N bits b_1 through b_N. Each symbol b_i is associated with a symbol parameter x_{b_i} and a recognition scalar R_{b_i} computed using the recognition mapping. The sender prepares a corresponding sequence of recognition states |psi_{b_1}> through |psi_{b_N}>, and the message state may be represented as a composite state |psi_message> that is a tensor product of the per-symbol states. In one embodiment, |psi_message>=tensor_product_{i=1 . . . N} |psi_{b_i}>.

As used herein, a “recognition key” refers to a key that is used to parameterize or implement the encryption and decryption operations. In various embodiments, the recognition key may be represented as a quantum state, a set of quantum states, a classical seed or key schedule that controls preparation of quantum states, or a hybrid thereof. In one embodiment, a recognition key has length M over an alphabet of size A, thereby yielding a key space cardinality of A\hat{ }M.

In some embodiments, the recognition key is generated in association with a recognition frequency f_rec that is derived from an effective propagation velocity v_eff and an effective recognition length L_rec. In one embodiment, f_rec=v_eff/(X_opt*L_rec), where v_eff>0, L_rec>0, and X_opt>0. In various implementations, v_eff may correspond to a group velocity in an optical medium, an effective signal velocity in a transmission structure, or another effective propagation parameter, and L_rec may correspond to an effective interaction length, resonator length, waveguide length, cavity length, or other engineered length scale associated with the encryption interaction.

In some embodiments, an encryption interaction is parameterized by a coupling constant g_crypto that is likewise derived from v_eff, L_rec, and X_opt. In one embodiment, g_crypto=(hbar*v_eff)/(X_opt*L_rec), where hbar is the reduced Planck constant. When hbar>0, v_eff>0, L_rec>0, and X_opt>0, the coupling constant g_crypto is positive. In various embodiments, g_crypto corresponds to an interaction energy scale, a gate-strength parameter, or another coupling parameter suitable for implementing a recognition-coupled encryption transformation on a quantum information processing platform.

In one embodiment, encryption is implemented using a recognition-coupled Hamiltonian H_hat_crypto that depends on a message-associated recognition operator and a key-associated recognition operator. In one embodiment, H_hat_crypto=−g_crypto*R_hat_message*R_hat_key, where R_hat_message acts on a message subsystem and R_hat_key acts on a key subsystem. In some embodiments, the Hamiltonian is implemented as an effective interaction term in a physical platform, such as a controlled-phase interaction, a cross-phase modulation interaction, an engineered two-body coupling, or another interaction that can be calibrated to implement the disclosed recognition-coupled transformation.

In one embodiment, the encryption transformation is a unitary operator U_hat_crypto derived from the Hamiltonian H_hat_crypto. In one embodiment, U_hat_crypto=exp(−i*H_hat_crypto*t/hbar), where t is an interaction time, gate time, or effective dwell time. In operation, a sender applies U_hat_crypto to the message state to produce an encrypted state. In one embodiment, |psi_encrypted>=U_hat_crypto*|psi_message>.

In one embodiment, decryption is implemented by applying an inverse transformation corresponding to U_hat_crypto. In one embodiment, |psi_decrypted>=U_hat_crypto\hat{ }{−1}*|psi_encrypted>. In unitary embodiments, U_hat_crypto\hat{ }{−1} may be implemented as U_hat_crypto\hat{ }{dagger}=exp(+i*H_hat_crypto*t/hbar). In this manner, the decryption operation reverses the encryption operation to recover the original message state, such that decrypt(encrypt(m))=m for supported implementations.

In various embodiments, the RSQIE system further performs verification to detect or indicate interception, tampering, or other mismatch conditions. In one embodiment, verification includes computing a coherence deviation deltaR defined as deltaR=abs(R_expected−R_measured), where R_expected is an expected recognition scalar and R_measured is an estimated recognition scalar obtained from measurements performed by the receiver. In one embodiment, deltaR is compared to a threshold, and a breach indication is generated when deltaR exceeds the threshold. In disturbance-sensitive embodiments, an adversary's interaction with the transmitted quantum states may cause a measurable deviation in recognition statistics, thereby increasing deltaR and providing an indication of interception or tampering.

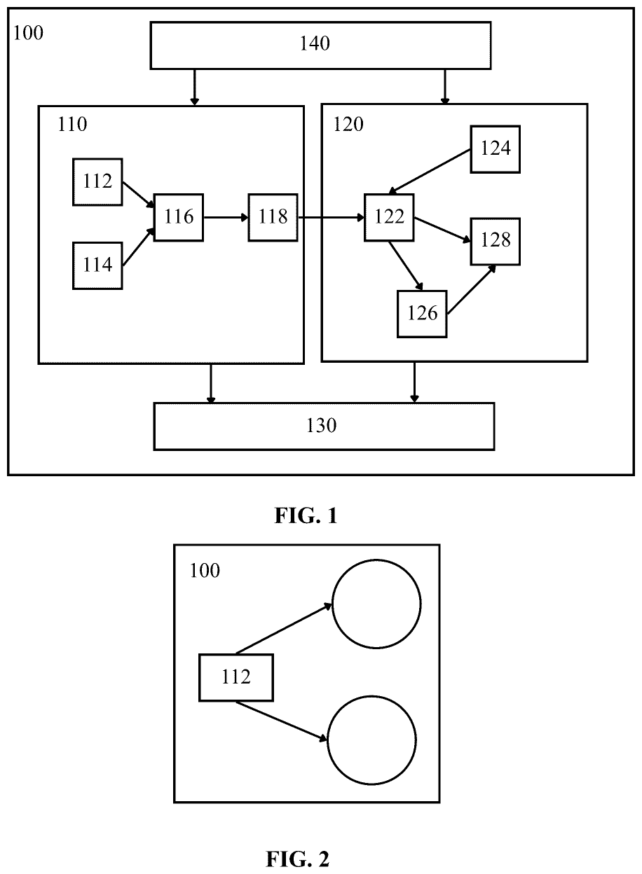

FIG. 1 illustrates an example end-to-end RSQIE system 100 including a sender device 110, a receiver device 120, a communication channel 130, and, in some embodiments, a classical control channel 140. The sender device 110 includes an encoder 112 configured to map digital symbols to recognition scalars and to prepare corresponding recognition states, a key module 114 configured to generate or provision a recognition key, an encryption module 116 configured to apply a recognition-coupled encryption transformation to produce an encrypted quantum state, and an output interface 118 configured to transmit the encrypted state via the channel 130. The receiver device 120 includes an input interface 122 configured to receive the encrypted state, a decryption module 124 configured to apply an inverse transformation to recover a decrypted state, a measurement and decoding module 126 configured to reconstruct the digital symbols, and a verification module 128 configured to compute a coherence deviation metric and to trigger one or more responsive actions based on a trigger condition.

In one embodiment, the sender device 110 receives a plaintext message m comprising a sequence of symbols. The encoder 112 selects symbol-associated parameters x_b for the symbols, computes corresponding recognition scalars R_b using the recognition mapping, and prepares corresponding quantum states representing the message. The key module 114 generates or provisions a recognition key that parameterizes the encryption module 116. The encryption module 116 applies the encryption transformation U_hat_crypto to produce |psi_encrypted>, and the output interface 118 transmits |psi_encrypted> via the communication channel 130.

In one embodiment, the receiver device 120 receives |psi_encrypted> via the input interface 122.

The decryption module 124 applies U_hat_crypto\hat{ }{−1} to produce |psi_decrypted>. The measurement and decoding module 126 performs measurements to estimate recognition values and reconstruct the corresponding symbols to recover the plaintext message. The verification module 128 computes deltaR between expected and measured recognition values and, when deltaR exceeds a threshold, triggers a responsive action, such as discarding a packet, generating an alert, initiating rekeying, logging an event, or altering a session state.

In various embodiments, the modules described herein may be implemented using one or more processors and one or more memories storing instructions that, when executed, cause performance of the recognition-scalar computation, key scheduling, state preparation control, encryption transformation control, decryption transformation control, measurement/estimation, and verification/response operations described herein. Such implementations may further include quantum state preparation and measurement hardware, analog or digital control circuitry (e.g., timing, modulation, and gate-control circuitry), and communication interfaces for the quantum channel and, where used, a classical control channel. The functional partitioning shown in FIG. 1 is illustrative, and functions may be combined, divided, distributed, or otherwise arranged without departing from the scope of the present disclosure.

FIG. 2 illustrates an example symbol encoding using recognition scalars. In one embodiment, a binary alphabet is used in which a first symbol (bit “0”) is associated with x0 and a second symbol (bit “1”) is associated with x1, where x0 and x1 are positive values and x0 !=x1. The corresponding recognition scalars are computed as R0=x0/(x0+X_opt) and R1=x1/(x1+X_opt). In one embodiment, X_opt is set to phi/pi. In some embodiments, the encoder prepares a quantum state |psi_0> corresponding to R0 and a quantum state |psi_1> corresponding to R1, such that measurement statistics of the prepared state enable estimation of the associated recognition scalar.

In some embodiments, the recognition scalar is mapped to a qubit amplitude relationship. For example, in one embodiment, |psi_b>=sqrt(R_b)|0>+sqrt(1−R_b)|1>, where |0> and |1> are basis states of a qubit. Measurement of the state in the {|0>, |1>} basis yields outcome probabilities that permit estimation of R_b, thereby enabling decoding. In other embodiments, the recognition scalar is mapped to a phase parameter, a polarization parameter, a time-bin ratio, a frequency-bin ratio, or a continuous-variable quadrature parameter, and the receiver estimates R_b from corresponding measurements.

In some embodiments, the encoding generalizes to an alphabet of size A greater than two. In one embodiment, symbols are indexed by j in {0, 1, . . . , A−1}, each symbol is associated with a distinct positive value x_j, and the corresponding recognition scalar is computed as R_j=x_j/(x_j+X_opt). In this manner, each transmitted symbol can represent log 2(A) bits, and the key space and message space may be expanded accordingly.

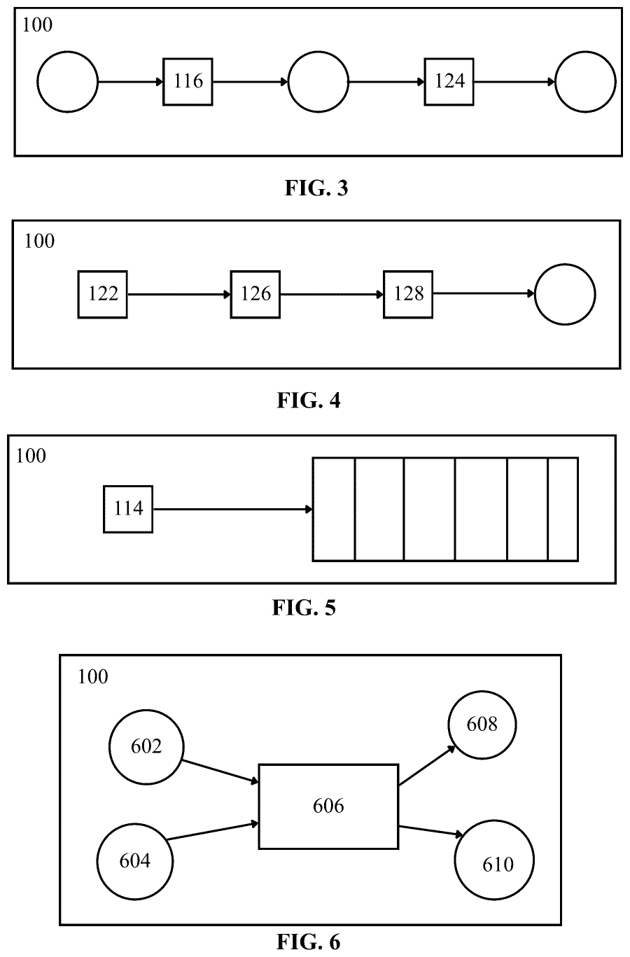

FIG. 3 illustrates an example encryption and decryption process using the recognition-coupled Hamiltonian H_hat_crypto and unitary transformation U_hat_crypto. In one embodiment, the encryption module implements U_hat_crypto=exp(−i*H_hat_crypto*t/hbar) where H_hat_crypto=−g_crypto*R_hat_message*R_hat_key. The encryption module applies U_hat_crypto to the message state to produce an encrypted state for transmission or storage. The decryption module implements the inverse transformation U_hat_crypto\hat{ }{−1} and applies it to the encrypted state to recover the decrypted state.

In various embodiments, the recognition-coupled interaction is implemented using platform-specific operations. For example, in photonic embodiments, the interaction may be implemented using an optical modulator, interferometric elements, or a non-linear medium configured to apply a key-dependent phase shift. In superconducting qubit embodiments, the interaction may be implemented using an engineered two-qubit coupling that realizes a controlled-phase operation. In trapped-ion embodiments, the interaction may be implemented using a laser-driven entangling gate. These examples are illustrative and do not limit the scope of the disclosure.

FIG. 4 illustrates an example verification pipeline. In one embodiment, the receiver computes an expected recognition scalar R_expected for one or more check symbols, reference symbols, or payload symbols based on the known encoding rules and keying context. The receiver also estimates a measured recognition scalar R_measured from measurement outcomes. The verification module computes deltaR=abs(R_expected−R_measured) and compares deltaR to a threshold. When deltaR exceeds the threshold, the verification module generates a breach indication and triggers one or more responsive actions. In some embodiments, deltaR is computed on a rolling window basis over multiple symbols to reduce sensitivity to noise and to improve detection confidence.

FIG. 5 illustrates an example key structure and key space scaling. In one embodiment, a recognition key is formed from M elements over an alphabet of size A, yielding a key space of A\hat{ }M. When A is two, the key space is 2\hat{ }M, which grows exponentially with key length M. In some embodiments, key elements correspond to discrete selection of x values, basis choices, phase shifts, or other parameters used to prepare or transform quantum states. In some embodiments, the key is generated using quantum randomness sources and is refreshed periodically or in response to a trigger event, such as an elevated deltaR value.

FIG. 6 illustrates an example no-cloning constraint relevant to disturbance-sensitive embodiments. In general, a hypothetical universal cloning operation would require that inner products between arbitrary states be preserved under cloning in a manner that implies z\hat{ }2=z for all overlap values z. The relation z\hat{ }2=z holds only for z in {0, 1}, but non-orthogonal quantum states can have overlap values strictly between 0 and 1. Accordingly, unknown superposition states cannot be universally cloned. In certain embodiments, this constraint supports the property that an adversary cannot perfectly copy transmitted encrypted states without disturbance, and such disturbance may be detectable through increased deviation in measured recognition statistics.

Referring to FIG. 6, system 100 illustrates a conceptual no-cloning constraint model in which a first unknown quantum input state 602 and a second unknown quantum input state 604 are provided to a hypothetical cloning operation 606.

The cloning operation 606 outputs a first purported clone 608 and a second purported clone 610. For arbitrary non-orthogonal input states, the outputs 608 and 610 cannot simultaneously be perfect copies of the corresponding inputs 602 and 604 under a universal transformation without violating inner-product preservation, consistent with the no-cloning principle discussed above.

In disturbance-sensitive embodiments, attempted interception or copying of encrypted quantum states may manifest as measurable deviation in recognition statistics (e.g., increased deltaR or increased dispersion of deltaR over a window), which can be used by the verification module to trigger a responsive action.

The embodiments described with reference to FIGS. 1-6 may be applied to data in transit, data at rest, or both. In data-in-transit embodiments, encrypted quantum states are transmitted over a quantum communication channel such as optical fiber, free-space optical links, or satellite links, with optional classical metadata transmitted over a classical control channel. In data-at-rest embodiments, encrypted representations are stored in memory systems and later decrypted for retrieval, and verification may be performed during retrieval to detect tampering or corruption. While specific embodiments and parameterizations have been described, the disclosed systems and methods may be implemented using any suitable quantum information processing platform, any suitable state preparation and measurement architecture, and any suitable control electronics and software. The described equations and mappings are intended to be illustrative embodiments that enable implementation and do not limit the scope of the claims.

In order to facilitate implementation on practical quantum hardware, the recognition mapping and related values may be realized through one or more calibrated physical observables. In one embodiment, a calibration procedure is performed to associate each intended recognition scalar value R (or each intended symbol-associated x value) with a corresponding state preparation control setting and a corresponding measurement model for estimating a measured recognition scalar R_measured. For example, calibration may generate a mapping table that associates a control parameter c with an achieved recognition scalar R(c) and an uncertainty estimate sigma_R(c), where c may include one or more of drive amplitude, phase, pulse width, polarization angle, interferometer phase, time-bin intensity ratio, frequency-bin ratio, or coherent-state quadrature displacement.

In one embodiment, a message-associated recognition operator R_hat_message is realized as an operator whose expectation value with respect to a prepared message state equals a corresponding recognition scalar. For example, in a two-level qubit embodiment, an observable Z_hat (Pauli-Z) may be measured, and the recognition scalar may be associated with the probability of obtaining a particular measurement outcome or with an affine mapping of the Z expectation. In one embodiment, the receiver estimates p0 as the probability of outcome “0” in a computational basis measurement, and sets R_measured=p0 (or sets R_measured as a deterministic function of p0) when the preparation mapping is selected such that p0 is intended to equal R. In another embodiment, the receiver estimates <Z_hat> and sets R_measured=(1+<Z_hat>)/2, thereby mapping the Z expectation to the interval [0, 1].

In one embodiment, the prepared qubit recognition state is controlled such that the recognition scalar is expressed in measurement statistics. For example, when |psi_b>=sqrt(R_b)|0>+sqrt(1−R_b)|1>, an ideal measurement in the {|0>,|1>} basis yields p0=R_b. In such embodiments, the recognition scalar may be estimated as R_measured=n0/(n0+n1), where n0 is the number of observed “0” outcomes and n1 is the number of observed “1” outcomes over a sampling window. The window may include repeated preparations of the same intended recognition state, repeated transmissions of the same symbol, or a designated set of check symbols.

In a phase-encoded embodiment, a recognition scalar R may be mapped to a phase theta using a predetermined mapping function, such as theta=F_phase(R), where F_phase is agreed between endpoints. In one embodiment, a non-limiting example is theta=2*pi*R. The sender prepares a phase-encoded state, and the receiver estimates theta_measured using interferometry or homodyne techniques, and then computes R_measured=F_phase\hat{ }{−1}(theta_measured). In such embodiments, the recognition scalar is still computed by the recognition mapping and is recovered from phase measurements via the agreed mapping.

In a polarization-encoded embodiment, a recognition scalar R may be mapped to a polarization control angle alpha using a predetermined mapping function, such as cos(alpha)\hat{ }2=R or alpha=arccos(sqrt(R)). The sender prepares photons (or other carriers) with polarization determined by alpha, and the receiver measures in an agreed basis to estimate alpha_measured and compute R_measured. In a time-bin or frequency-bin embodiment, the sender encodes R as an intensity ratio between two bins, and the receiver estimates the ratio using photon counting or spectral filtering and computes R_measured accordingly.

In a continuous-variable embodiment, the sender prepares a coherent state or squeezed state with quadrature displacement related to R by a predetermined mapping, such as q=F_cv(R). The receiver performs homodyne or heterodyne detection to estimate q_measured and computes R_measured=F_cv\hat{ }{−1}(q_measured). In such embodiments, the recognition mapping R=x/(x+X_opt) may be used at the control layer to select x values, while the physical layer uses the predetermined mapping between R and a continuous-variable control parameter.

In one embodiment, the key-associated recognition operator R_hat_key is realized in a manner analogous to R_hat_message, and may correspond to a register of key states, a set of key-dependent control parameters, or a hybrid thereof. For example, in a hybrid embodiment, a classical key schedule selects a sequence of key-dependent control parameters that drive a quantum modulation element, and those control parameters correspond to discrete key symbols whose associated recognition scalars are known to both endpoints. In another embodiment, a key register is a quantum register, and encryption is implemented using an interaction that couples the message subsystem to the key subsystem.

In one embodiment, the recognition-coupled Hamiltonian term H_hat_crypto=−g_crypto*R_hat_message*R_hat_key is implemented as an effective interaction whose strength is controlled by the product of message-associated and key-associated quantities. In a controlled-phase embodiment, a message qubit and a key qubit are coupled by an interaction that imparts a conditional phase shift. In such embodiments, an effective Hamiltonian may be expressed as H_eff=kappa*Z_hat_message*Z_hat_key for a calibrated coupling kappa, and the recognition-coupled interaction may be implemented by calibrating the state preparation and basis such that the effective interaction corresponds to the desired recognition-coupled transformation. In photonic embodiments, an analogous interaction may be implemented using cross-phase modulation, electro-optic modulation with key-dependent control, or interferometric networks configured to apply key-dependent phase shifts.

In one embodiment, calibration includes determining an interaction time t and a platform-specific control setting that yields an effective unitary operation corresponding to U_hat_crypto=exp(−i*H_hat_crypto*t/hbar ) within a tolerated error bound. In some embodiments, calibration produces a set of gate parameters for a plurality of supported recognition scalar values and key values, such that encryption and decryption may be performed repeatedly and reproducibly. In one embodiment, a best-mode calibration procedure includes measuring the fidelity of decrypted states relative to intended plaintext states and selecting parameters that maximize decoding accuracy while maintaining a desired detection sensitivity for deltaR.

In one embodiment, the receiver estimates recognition scalars using statistical aggregation. For example, for a given symbol index i, the receiver obtains an estimate R_measured(i) from measurements of one or more corresponding received states. In one embodiment, a sliding window of length K symbols is used to compute a windowed deviation statistic. For example, deltaR(i)=abs(R_expected(i)−R_measured(i)), and deltaR_mean=(1/K)*sum_{j=0 . . . K−1} deltaR(i−j). In another embodiment, the receiver computes a variance or dispersion statistic, such as var_deltaR over the same window, to distinguish noise from persistent disturbance.

In one embodiment, threshold selection is performed using calibration statistics collected under nominal conditions. For example, during initialization or periodic calibration, the receiver measures deltaR over known check symbols to obtain a baseline mean mu_delta and baseline standard deviation sigma_delta. The threshold T_R may then be set as T_R=mu_delta+k*sigma_delta, where k is a design parameter selected to achieve a target false-alarm rate. In some embodiments, multiple thresholds are used, including a warning threshold and an alarm threshold. In some embodiments, thresholding is adaptive and is updated when channel conditions or hardware drift are detected.

In some embodiments, the RSQIE system includes designated check symbols or pilot symbols inserted into the message stream to support robust estimation of R_measured and deltaR. For example, the sender may insert a predetermined pattern of check symbols at periodic intervals, and the receiver uses the known expected recognition scalars for those check symbols to compute calibration-aligned deviation statistics. In some embodiments, the system increases the density of check symbols in response to increased noise or an elevated deltaR_mean.

In some embodiments, responsive actions are policy-controlled based on the deviation statistics. For example, when deltaR_mean exceeds T_R, the receiver may discard one or more packets, reduce acceptance confidence, request retransmission, or initiate rekeying. In some embodiments, when deltaR_mean exceeds an alarm threshold, the receiver generates a breach indication, logs an event, and terminates the current session. In some embodiments, the receiver may also initiate a channel change, increase redundancy, or switch to a different encoding mapping to maintain availability.

In various embodiments, key management includes provisioning, generation, storage, scheduling, and rekeying. In one embodiment, a recognition key is pre-shared between endpoints out-of-band and stored in secure memory, such as a hardware security module. In another embodiment, a recognition key (or a classical seed used to derive recognition keys) is established using a quantum key distribution procedure, including non-limiting examples such as BB84 or E91, and is then used to parameterize RSQIE encryption of payload data. In another embodiment, the recognition key is generated using quantum randomness sources, including non-limiting examples such as vacuum fluctuation sampling, spontaneous emission sampling, shot-noise-limited photodetection, or other quantum-derived randomness sources, optionally clocked or filtered using f_rec.

In some embodiments, a key schedule derives per-session and per-message keys from a master key. For example, a master key K_master may be used to derive a session key K_session and a per-message key K_msg using a deterministic key-derivation function or a pseudorandom function, and K_msg may select symbol-associated x values, basis choices, phase offsets, or other parameters for the message. In hybrid embodiments, the derived keys may be classical but control the preparation of quantum key states or quantum modulation elements.

In some embodiments, rekeying is triggered by time, data volume, or verification statistics. For example, the system may rekey after a predetermined number of symbols, after a predetermined duration, or when deltaR_mean exceeds a threshold. In one embodiment, when deltaR_mean exceeds a rekey threshold, the receiver requests rekeying via a classical control channel, discards unverified ciphertext states, and resumes secure communication using a newly generated or newly provisioned recognition key. In some embodiments, rekeying includes transmitting a confirmation message, verifying synchronization, and resuming encryption under the new key schedule.

In some embodiments, the RSQIE system supports data-at-rest protection. In one embodiment, data is partitioned into blocks, each block is encoded into recognition states or recognition-coded ciphertext representations, and each block is associated with a block key K_block derived from the key schedule. The encrypted representations are stored in a storage medium along with metadata sufficient for retrieval, such as block index, session identifier, error-correction metadata, and optional authentication tags. Upon retrieval, the system decrypts the stored representation using the corresponding keying context and computes deltaR for one or more stored check values or derived recognition values to detect tampering, corruption, or substitution.

In some embodiments, the RSQIE system includes error handling and reconciliation. For example, when channel loss or device noise is present, the receiver may use redundancy, forward error correction, or repeated sampling to estimate R_measured with sufficient confidence. In some embodiments, the system applies a decision rule that includes a confidence metric, such as accepting a decoded symbol only when the estimated recognition scalar is within a tolerance band of an expected symbol scalar, and otherwise marking the symbol as an erasure for later correction.

In some embodiments, the system supports multi-level encoding (A greater than two) to improve throughput. In such embodiments, a symbol set includes x_j values for j in {0, 1, . . . , A−1}, and the receiver decodes by selecting the nearest expected recognition scalar or by applying a maximum-likelihood rule based on a noise model. In some embodiments, the key schedule selects among multiple symbol sets or multiple mappings to increase uncertainty for an adversary.

In disturbance-sensitive embodiments, the no-cloning constraint described above supports a security property in which an adversary cannot perfectly copy unknown transmitted quantum ciphertext states without disturbance. In one embodiment, such disturbance manifests as increased variance or bias in measurement outcomes used to compute R_measured, thereby increasing deltaR and triggering detection logic. In some embodiments, the system further uses decoy states or randomized basis choices to increase the detectability of interception, while maintaining the disclosed recognition mapping and verification logic.

In various embodiments, RSQIE may be deployed as a standalone encryption layer or integrated into existing network and application stacks. For example, in one embodiment, RSQIE encrypts payload data while a classical channel carries session establishment metadata, acknowledgments, and rekey coordination. In another embodiment, RSQIE is used in combination with post-quantum cryptography to protect the classical control channel, while RSQIE provides direct payload encryption and recognition-based verification. These integration embodiments are illustrative and do not limit the scope of the disclosure.

While specific embodiments and parameterizations have been described, the disclosed systems and methods may be implemented using any suitable quantum information processing platform, any suitable state preparation and measurement architecture, and any suitable control electronics and software. The described equations, mappings, calibration procedures, estimation procedures, thresholding procedures, and key-management procedures are intended to be illustrative embodiments that enable implementation and do not limit the scope of the claims.

In one best-mode embodiment, the RSQIE system is implemented as a photonic link in which the communication channel 130 comprises optical fiber and the quantum carriers comprise photons prepared with polarization-encoded or phase-encoded states. In this embodiment, the encoder 112 selects a binary symbol set with two distinct positive values x0 and x1 and computes corresponding recognition scalars R0 and R1 using R_b=x_b/(x_b+X_opt), where X_opt=phi/pi. In one embodiment, the encoder 112 maps each recognition scalar R_b to a polarization angle alpha_b such that cos(alpha_b)\hat{ }2=R_b, prepares photons with polarization corresponding to alpha_b, and transmits the prepared states as a sequence corresponding to the plaintext bits.

In the best-mode embodiment, the receiver estimates a measured recognition scalar R_measured from polarization measurements. For example, for a given symbol or for a sampling window corresponding to repeated preparations, the receiver measures counts n0 and n1 in an agreed polarization basis and computes R_measured=n0/(n0+n1). In one embodiment, decoding is performed by comparing R_measured to the expected recognition scalar set {R0, R1} and selecting the symbol whose expected scalar is closest to R_measured, subject to a confidence criterion based on measurement uncertainty.

In one best-mode embodiment, the encryption module 116 implements the encryption transformation using a key-dependent phase shift realized by an optical modulation element, such as an electro-optic phase modulator, an interferometric phase shifter, or a non-linear element configured to impart a conditional phase. In one embodiment, a classical key schedule controls the modulator settings to realize the effect of a recognition-coupled interaction between the message-associated recognition quantity and the key-associated recognition quantity. The decryption module 124 applies inverse modulation settings synchronized to the sender's key schedule to reverse the encryption and recover the message-associated recognition states for measurement and decoding.

In one calibration procedure for the best-mode embodiment, the system initializes by selecting a set of intended recognition scalar values including at least R0 and R1, preparing corresponding states, and measuring those states at the receiver to estimate baseline statistics under nominal conditions. In one embodiment, the system generates a calibration record that includes, for each intended scalar value, (i) a control setting used by the sender (e.g., polarization angle or phase), (ii) an estimated mean recognition value at the receiver, and (iii) an uncertainty estimate. In one embodiment, the system further calibrates the encryption interaction by applying a known key pattern and measuring the resulting decrypted-state fidelity, and then selecting interaction parameters that maximize successful recovery while maintaining verification sensitivity.

In one best-mode embodiment, verification is performed using windowed deviation statistics. In one embodiment, the sender inserts predetermined check symbols at periodic intervals, and the receiver computes deltaR(i)=abs(R_expected(i)−R_measured(i)) for check-symbol positions. In one embodiment, the receiver computes a rolling mean deltaR_mean over a window of length K check symbols and compares deltaR_mean to a threshold T_R. In one embodiment, T_R is selected from calibration statistics by computing a baseline mean mu_delta and baseline standard deviation sigma_delta under nominal conditions and setting T_R=mu_delta+k*sigma_delta, where k is selected to achieve a target false-alarm rate.

In one embodiment, upon detecting that deltaR_mean exceeds T_R, the receiver triggers a responsive action selected from the group consisting of: (i) generating an alert, (ii) discarding one or more packets or frames, (iii) requesting retransmission, (iv) terminating a session, (v) initiating rekeying, (vi) increasing redundancy or check-symbol density, and (vii) switching to an alternative encoding mapping. In some embodiments, the system distinguishes transient noise from persistent anomalies by additionally computing a dispersion metric such as var_deltaR over the window and applying decision logic that requires both deltaR_mean and var_deltaR to exceed corresponding thresholds to declare a breach.

In one embodiment, message framing and synchronization are performed using one or more preamble states and sequence metadata. In one embodiment, the sender transmits a preamble comprising a predetermined sequence of recognition states that permit the receiver to detect frame boundaries, align measurement timing, and estimate channel drift. In one embodiment, the sender further transmits a frame header over the classical control channel 140 including a session identifier, a frame sequence number, a key schedule index, and optional error-correction metadata. In some embodiments, the receiver uses the preamble measurements to update calibration parameters used to compute R_measured and to maintain decoding accuracy.

In one embodiment, the system supports data-at-rest encryption by encrypting data blocks and storing encrypted representations together with retrieval metadata. In one embodiment, plaintext data is partitioned into blocks, each block is associated with a block identifier and a block key K_block derived from a key schedule, and the block is encoded into recognition states or recognition-coded ciphertext representations. In one embodiment, the stored metadata includes at least a block identifier, a session identifier or epoch identifier, and a key schedule index that permits authorized reconstruction of the keying context at retrieval time.

In one data-at-rest embodiment, the encrypted representation stored for a block includes (i) a ciphertext representation derived from the encrypted quantum states and (ii) one or more verification values that support later integrity checking. For example, in one embodiment, the system stores a set of check-symbol results or a compressed representation of expected recognition scalars for designated check positions. Upon retrieval, the system reconstructs the keying context, decrypts the stored representation, estimates R_measured for one or more verification positions, computes deltaR values, and flags tampering when the deviation statistics exceed a threshold.

In one embodiment, storage-time tampering detection is enhanced by storing an audit log entry for each encrypted block. In one embodiment, the audit log entry includes a block identifier, a timestamp, a session identifier, and one or more integrity indicators derived from recognition statistics, such that unauthorized modification of stored ciphertext or metadata results in an elevated deltaR or an inconsistent reconstruction during retrieval. In some embodiments, the audit log is stored in an append-only structure or is protected using an additional authentication mechanism.

In one embodiment, the RSQIE system is implemented on a superconducting-qubit platform. In this embodiment, message qubits represent recognition states and key qubits represent key states. The encryption interaction is implemented using a calibrated two-qubit coupling that realizes a controlled-phase operation between a message qubit and a key qubit. In one embodiment, the recognition scalar is mapped to a qubit preparation angle, and measurement in a computational basis yields an estimate of R_measured. The coupling strength and interaction time are calibrated so that the net effect corresponds to the desired encryption transformation and its inverse.

In one embodiment, the RSQIE system is implemented on a trapped-ion platform. In this embodiment, internal states of ions represent qubits or qudits, and entangling gates driven by laser pulses implement the encryption interaction. In one embodiment, the recognition scalar is mapped to a preparation parameter such as a rotation angle, and the encryption and decryption operations are performed using a calibrated sequence of single-qubit rotations and entangling gates such that the receiver can apply an inverse sequence to recover the plaintext states for measurement and decoding.

In one embodiment, the RSQIE system is implemented as a continuous-variable (CV) system using coherent states and homodyne detection. In this embodiment, the sender maps recognition scalars to quadrature displacements and prepares a sequence of coherent states accordingly. The encryption interaction is implemented by applying a key-dependent displacement, phase rotation, or squeezing operation that is reversible under the corresponding inverse key-dependent operation. The receiver performs homodyne measurements to estimate quadrature values and computes R_measured using an inverse mapping. Verification is performed using deltaR computed between expected and measured values as described herein.

In one embodiment, the system supports multi-level encoding and multi-level keys to increase throughput and key space. In one embodiment, the sender selects an alphabet size A greater than two and defines a set of distinct positive values x_j for j in {0, 1, . . . , A−1}. The sender computes recognition scalars R_j=x_j/(x_j+X_opt) and uses those scalars to prepare corresponding states. The receiver decodes by selecting the most likely symbol given R_measured and a noise model, and the key schedule may select among multiple symbol sets or multiple mappings to further increase uncertainty to an adversary.

In one embodiment, the system supports hybrid operation with quantum key distribution (QKD). In one embodiment, endpoints establish a shared key using a QKD protocol and then use the resulting shared key material as a master key or seed to derive recognition keys or key schedules used by RSQIE. In such embodiments, RSQIE may be used to encrypt payload data directly while QKD provides key establishment, and the verification metric deltaR may be used as an additional integrity indicator for the RSQIE-encrypted payload.

In one embodiment, the system supports hybrid operation with post-quantum cryptography (PQC) to protect classical control messages. In one embodiment, PQC is used to authenticate or encrypt metadata transmitted over the classical control channel 140, including session identifiers, key schedule indices, acknowledgments, or rekey coordination messages, while RSQIE provides encryption and verification for the quantum-carried payload. This hybrid configuration can improve robustness against classical channel attacks while retaining the properties of RSQIE described herein.

In one embodiment, the system provides an application programming interface (API) that exposes functions for initializing a session, provisioning keys, encoding plaintext, encrypting a payload, decrypting a payload, computing verification metrics, and initiating rekeying. In one embodiment, the API is used by applications including secure messaging, secure file storage, IoT authentication, and secure backbone communication, and the underlying quantum hardware is controlled by device drivers and calibration routines as described herein.

The foregoing best-mode and additional embodiments are illustrative and are not intended to limit the scope of the disclosure. Any of the described encoding mappings, key provisioning approaches, encryption interaction realizations, measurement approaches, estimation approaches, thresholding approaches, key management procedures, rekeying triggers, and deployment configurations may be used alone or in combination, and may be adapted to particular quantum hardware platforms and channel conditions while remaining within the scope of the appended claims.

In one embodiment, the RSQIE system supports a session establishment procedure that coordinates parameter selection, calibration alignment, and key schedule synchronization between endpoints. In one embodiment, a sender and receiver establish a session identifier and negotiate or agree upon (i) an encoding alphabet size A, (ii) a mapping function between recognition scalars and physical control parameters, (iii) a measurement basis or measurement procedure for estimating R_measured, (iv) a check-symbol insertion policy, (v) a window size K for deviation statistics, and (vi) a key schedule epoch. In some embodiments, the session establishment procedure is performed using a classical authenticated channel, including in embodiments where the classical channel is protected using a post-quantum authentication mechanism.

In one embodiment, the session establishment procedure includes a calibration-alignment exchange. In one embodiment, the sender transmits a calibration frame comprising known recognition states corresponding to one or more predetermined recognition scalars. The receiver measures the calibration frame to estimate one or more calibration parameters, including a baseline mapping between control settings and measured recognition values, and optionally transmits calibration feedback to the sender. In some embodiments, the calibration-alignment exchange is repeated periodically, on demand, or when drift is detected, thereby maintaining decoding accuracy under changing channel or device conditions.

In one embodiment, the RSQIE system supports drift detection and compensation. Drift may include polarization drift, phase drift, frequency drift, amplitude drift, timing drift, or other variations that alter the relationship between transmitted states and measured recognition values. In one embodiment, the receiver detects drift by observing trends in R_measured for check symbols relative to expected values and applies a compensation update to the measurement model or to an inverse mapping function used to compute R_measured. In another embodiment, the sender applies compensation by adjusting state preparation control parameters based on feedback or based on a shared drift-estimation procedure.

In some embodiments, the system uses explicit synchronization markers. In one embodiment, a preamble includes a sequence of recognition states with known recognition scalars that provide timing alignment for gating measurement windows. In some embodiments, the receiver performs correlation against the expected preamble sequence to detect the start of a frame. In some embodiments, the preamble also supports estimation of channel parameters such as loss, polarization rotation, or phase offset, which can be used to update calibration and improve estimation of R_measured.

In one embodiment, the RSQIE system uses a layered framing structure. In one embodiment, a frame includes: (i) a preamble, (ii) a header, (iii) a payload, and (iv) an optional trailer. In one embodiment, the header includes a sequence number and a key schedule index, and the payload includes recognition-encoded ciphertext states. In some embodiments, the trailer includes check symbols, error-correction parity, or other verification material. In some embodiments, the header or trailer is transmitted over a classical channel and is authenticated, while the payload is transmitted as quantum states.

In one embodiment, the RSQIE system supports selective verification policies that trade throughput for detection sensitivity. In one embodiment, the system verifies every symbol, which maximizes sensitivity but can increase measurement overhead. In another embodiment, the system verifies only designated check symbols inserted at periodic intervals, which reduces overhead. In another embodiment, the system verifies a random subset of payload symbols, which can increase adversary uncertainty. The verification density may be selected based on channel conditions, risk policies, or application requirements.

In one embodiment, the RSQIE system supports multiple decision rules for decoding symbols. In one embodiment, a threshold rule is used in which a measured recognition scalar R_measured is compared to one or more thresholds that partition the recognition scalar range into symbol decision regions. In another embodiment, a maximum-likelihood rule is used in which the receiver selects the symbol j that maximizes P(R_measured|j) under a noise model. In another embodiment, a minimum-distance rule is used in which the receiver selects the symbol whose expected recognition scalar R_j minimizes abs(R_measured−R_j). These decision rules may be selected or tuned to achieve target error rates.

In one embodiment, the RSQIE system supports redundancy for improved decoding and verification robustness. In one embodiment, a symbol is represented using multiple repeated recognition states, and the receiver aggregates measurements across the repeated states to estimate R_measured with reduced variance. In another embodiment, the system uses forward error correction (FEC) applied to the symbol stream, such as a block code or convolutional code, and the receiver performs FEC decoding after obtaining symbol likelihoods. In another embodiment, the system uses erasure marking, where symbols with low confidence are marked as erasures for correction.

In one embodiment, the RSQIE system supports end-to-end integrity actions. In one embodiment, when the verification module determines that deltaR exceeds a threshold, the receiver generates an integrity failure indication that may be propagated to an application layer. In one embodiment, the application layer may respond by rejecting a transaction, invalidating a stored file, or prompting a user or administrator. In some embodiments, integrity failure indications are logged with contextual metadata, including a timestamp, session identifier, and frame sequence number, to support audit and incident response.

In some embodiments, the system supports multi-hop or network-node deployments. In one embodiment, RSQIE endpoints are deployed at network gateways such that traffic is encrypted between gateways. In another embodiment, RSQIE is deployed end-to-end between endpoints. In some embodiments, intermediate nodes perform routing without decryption, while in other embodiments trusted nodes decrypt and re-encrypt using separate keys on each hop. These deployment choices may be selected based on trust models, channel availability, and application requirements.

In one embodiment, the RSQIE system supports a “store-and-forward” configuration in which encrypted quantum states are buffered at an intermediate node for later transmission. In such embodiments, the buffer node stores a representation of the encrypted states and associated metadata sufficient for forwarding while preserving confidentiality. In some embodiments, the buffer node additionally stores verification-related metadata and may perform limited integrity checks without decrypting payload content, such as checking expected framing structure or expected check-symbol positions.

In one embodiment, the RSQIE system supports access control and authorization for decryption. In one embodiment, the receiver device requires possession of a recognition key or a master seed to reconstruct per-session or per-message keys used for decryption. In some embodiments, keys are protected within a hardware security module, trusted execution environment, secure enclave, or other protected environment. In some embodiments, decryption is permitted only when an authorization policy is satisfied, and failed authorizations are logged.

In one embodiment, the RSQIE system supports role-based key separation. For example, in a storage environment, a first entity may be authorized to write encrypted content using an encryption key schedule, while a second entity is authorized to decrypt using a corresponding decryption key schedule. In another embodiment, an auditing entity is authorized to verify integrity using deltaR-based checks without being authorized to decrypt payload content. Such separations may be implemented using distinct keys, distinct key derivation contexts, or distinct verification-only keys.

In one embodiment, the RSQIE system supports secure firmware or software updates for devices that perform RSQIE operations. In one embodiment, update packages are authenticated and verified, and RSQIE keys or calibration records are preserved or migrated securely during updates. In some embodiments, an update process triggers a re-calibration or rekeying procedure to ensure that recognition mappings and verification thresholds remain valid.

In one embodiment, the RSQIE system supports policy-controlled parameter selection for different application classes. For example, high-security applications may use larger key lengths M, larger window sizes K, higher verification densities, and more conservative thresholds to reduce false negatives. Lower-latency applications may use smaller K or lower verification density to improve throughput. In some embodiments, parameter policies are configured by an administrator and enforced by the system's control logic.

In one embodiment, the RSQIE system supports optional decoy-state techniques to enhance detection of interception in disturbance-sensitive implementations. In one embodiment, the sender randomly inserts decoy states having recognition scalars selected from a decoy set that is known to the receiver. The receiver measures the decoy states and computes deltaR statistics for the decoy positions. Because an adversary does not know which states are decoys, interception attempts can increase deviations in decoy statistics and thereby increase detection probability. The use of decoy states is optional and may be combined with any of the encoding and verification approaches described herein.

In one embodiment, the RSQIE system supports side-channel mitigation. Side-channel mitigations may include randomizing timing, randomizing basis choices, randomizing state preparation order, shielding measurement hardware, monitoring detector statistics for anomalies, limiting information leakage in classical metadata, and applying secure coding practices for software modules. These mitigations may reduce vulnerability to implementation attacks and may be used in conjunction with the RSQIE core mechanisms disclosed herein.

In one embodiment, the RSQIE system supports a compliance or certification workflow. In one embodiment, a set of properties, including distinctness of symbol recognition scalars, reversibility of encryption/decryption, non-negativity and match conditions for deltaR, exponential growth of key space, and no-cloning constraints, may be formally verified using a proof system. In some embodiments, proof artifacts are generated and stored as certification evidence that the implemented system conforms to specified properties. Such certification workflows are optional and do not limit the scope of the claimed subject matter.

The described embodiments may be used in a variety of contexts including secure banking transactions, government or military communications, cloud data center protection, IoT authentication, and quantum network backbones. In each context, the RSQIE system may be configured to meet application-specific requirements for throughput, latency, detection sensitivity, and key management while maintaining the recognition mapping, encryption/decryption operations, and verification logic described herein.

It will be understood that the particular ordering of operations described herein is illustrative. In various embodiments, operations may be reordered, combined, performed concurrently, or distributed across devices. Likewise, the specific implementations of state preparation, encryption interactions, measurement procedures, estimation procedures, thresholding procedures, key provisioning procedures, and deployment architectures described herein may be varied without departing from the scope of the appended claims.

The foregoing description of the embodiments has been provided for purposes of illustration and description. It is not intended to be exhaustive or to limit the disclosure to the precise forms disclosed. Modifications and variations are possible in light of the above teachings or may be acquired from practice of the disclosed embodiments. The embodiments were chosen and described in order to explain the principles of the disclosure and its practical application and to enable others skilled in the art to utilize the disclosure in various embodiments and with various modifications as are suited to the particular use contemplated.

In one embodiment, the RSQIE system performs a complete end-to-end encryption workflow as follows. A sender selects an alphabet size A and a symbol set of positive values x_j for j in {0, 1, . . . , A−1}. For each plaintext symbol, the sender computes a corresponding recognition scalar R_j using R_j=x_j/(x_j+X_opt), where X_opt is a predetermined constant and, in some embodiments, X_opt=phi/pi. The sender prepares a corresponding recognition state according to an agreed physical mapping between R_j and a controllable state parameter, encrypts the resulting message state using a recognition key and a recognition-coupled transformation, and transmits the encrypted state(s) via a quantum channel.

In one embodiment, the encryption workflow includes computing the recognition frequency and coupling constant based on platform-specific parameters. In one embodiment, f_rec=v_eff/(X_opt*L_rec) and g_crypto=(hbar*v_eff)/(X_opt*L_rec), where v_eff is an effective propagation velocity and L_rec is an effective recognition length. In some embodiments, the sender uses f_rec as a clocking or filtering reference for key generation, state preparation timing, and/or modulation control such that encryption and decryption operations remain synchronized across the session.

In one embodiment, the sender generates or provisions a recognition key and initializes a key schedule. In one embodiment, the key schedule defines (i) per-frame key indices, (ii) per-frame or per-block control parameters for state preparation and/or encryption modulation, and (iii) any check-symbol policies. In one embodiment, the sender transmits session metadata (e.g., session identifier, epoch identifier, and key schedule index) over a classical control channel that is authenticated. In some embodiments, the metadata is additionally protected using post-quantum authentication or encryption.

In one embodiment, the sender encrypts a prepared message state by applying an encryption transformation derived from a recognition-coupled interaction. In one embodiment, the sender applies U_hat_crypto=exp(−i*H_hat_crypto*t/hbar), where H_hat_crypto=−g_crypto*R_hat_message*R_hat_key. In practical implementations, the sender may realize U_hat_crypto using a calibrated gate, a calibrated modulation waveform, an interferometric network, or another reversible physical transformation controlled by the key schedule. The sender then transmits the encrypted states or stores an encrypted representation.

In one embodiment, a receiver performs a corresponding decryption workflow. The receiver obtains or reconstructs the key schedule context and applies a corresponding inverse transformation to the received encrypted states. In one embodiment, the receiver applies U_hat_crypto\hat{ }{−1}=exp(+i*H_hat_crypto*t/hbar) to obtain decrypted states that correspond to the original recognition states. The receiver then measures the decrypted states using an agreed measurement procedure and decodes symbols based on estimated recognition values.

In one embodiment, the receiver estimates R_measured for each decoded symbol or for designated verification symbols by aggregating measurement outcomes. For example, in a counting embodiment, the receiver obtains counts n0 and n1 corresponding to outcomes associated with an intended scalar and computes R_measured=n0/(n0+n1). In a phase embodiment, the receiver estimates a phase parameter and computes R_measured from an inverse mapping. In a continuous-variable embodiment, the receiver estimates a quadrature value and computes R_measured from an inverse mapping. The receiver may compute confidence intervals or uncertainty estimates and may mark low-confidence symbols as erasures.

In one embodiment, the receiver computes expected recognition values for verification positions. In one embodiment, R_expected values are derived from the known symbol set and the known positions of check symbols, pilot symbols, or predetermined reference states. In another embodiment, R_expected values are derived from a key-dependent schedule known to authorized endpoints. The receiver computes deltaR=abs(R_expected−R_measured) for one or more verification positions and compares deltaR or a windowed statistic to a threshold.

In one embodiment, verification is performed using a windowed statistic to reduce sensitivity to noise and to support robust breach indication. In one embodiment, for a rolling window of length K verification positions, the receiver computes deltaR_mean=(1/K)*sum_{i=1 . . . K} abs(R_expected(i)−R_measured(i)). In one embodiment, the receiver also computes var_deltaR over the window. As used herein, a “trigger condition” or “trigger policy” refers to an objective decision rule that is satisfied when one or more deviation metrics exceed one or more corresponding thresholds, including non-limiting examples of (i) deltaR>T_R for at least one verification position, (ii) deltaR_mean>T_R over the window, (iii) var_deltaR>T_var over the window, and/or (iv) a Boolean combination of (i)-(iii). A breach indication may be generated when the trigger condition is satisfied.

In one embodiment, threshold selection is performed using baseline calibration data. In one embodiment, the receiver performs a baseline measurement sequence under nominal conditions and computes baseline statistics including mu_delta and sigma_delta for deltaR (or for deltaR_mean).

The receiver sets a threshold T_R=mu_delta+k*sigma_delta, where k is selected based on a desired balance between false alarms and missed detections. In some embodiments, the receiver updates threshold parameters adaptively when drift is detected or when channel conditions change.

In one embodiment, the RSQIE system supports a rekeying protocol that is triggered by verification statistics. In one embodiment, when deltaR_mean exceeds a rekey threshold, the receiver signals a rekey request via the classical control channel, discards subsequent frames until rekeying is complete, and switches to a new key schedule epoch. In one embodiment, the sender responds by generating a new recognition key or selecting new key material, confirming the new key schedule index, and transmitting a fresh calibration-alignment frame before resuming encrypted payload transfer.

In one embodiment, the RSQIE system supports multiple independent rekey triggers, including time-based rotation, volume-based rotation, and anomaly-based rotation. For example, the system may rekey after transmitting a predetermined number of frames, after a predetermined duration, after transmitting a predetermined amount of data, or when verification statistics exceed thresholds. The system may apply the most conservative trigger among these or may apply a policy-driven combination.

In one embodiment, the RSQIE system supports a key derivation hierarchy. In one embodiment, a master key K_master is used to derive a session key K_session, and K_session is used to derive per-message keys K_msg or per-block keys K_block. The derived keys may control state preparation mappings, encryption modulation parameters, check-symbol schedules, and/or basis choices. In hybrid embodiments, the master key may be obtained via QKD, a pre-shared secret, or quantum random number generation.

In one embodiment, the RSQIE system supports quantum random number generation (QRNG) as a key material source. In one embodiment, QRNG output is sampled and used to form key elements or a key seed. In some embodiments, QRNG sampling is coordinated with f_rec for timing stability or filtering. In one embodiment, the system validates QRNG output by monitoring entropy metrics and detector statistics and triggers a fallback policy if QRNG health checks fail.

In one embodiment, the RSQIE system supports secure storage of keys and calibration records. In one embodiment, keys and seeds are stored in a protected environment such as a hardware security module, trusted execution environment, secure enclave, or tamper-resistant memory. In one embodiment, calibration records include mappings between control parameters and recognition values and include threshold settings. In some embodiments, calibration records are integrity-protected and are associated with device identifiers and firmware versions.

In one embodiment, the RSQIE system supports secure data-at-rest storage formats. In one embodiment, encrypted content is stored as a set of ciphertext records, each record including a block identifier, a key schedule index, and a ciphertext representation. In some embodiments, a ciphertext representation includes a classical record derived from measurements of encrypted quantum states. In other embodiments, when supported by hardware, the ciphertext representation includes stored quantum states or stored quantum memory representations. Regardless of storage form, authorized retrieval includes reconstructing the key context, applying decryption, and verifying integrity using deltaR-based checks or derived recognition indicators.

In one embodiment, a storage integrity workflow proceeds as follows. At write time, the system generates a block key K_block, encrypts the block, and stores a ciphertext record together with verification material. At read time, the system reconstructs K_block, decrypts the ciphertext record to recover a plaintext block, computes verification statistics (including deltaR for check positions or derived indicators), and accepts the block only when verification statistics satisfy an acceptance policy. In one embodiment, the acceptance policy is satisfied when one or more deviation metrics remain within corresponding bounds, including non-limiting examples of deltaR_mean≤T_R over a window of verification positions and/or var_deltaR≤T_var over the window. When verification fails (i.e., the acceptance policy is not satisfied), the system flags the record as corrupted or tampered and triggers a response such as quarantining the record, alerting an administrator, initiating rekeying, and/or retrieving from a redundant replica.

In one embodiment, the RSQIE system supports authentication of endpoints using recognition-based challenge-response. In one embodiment, an authenticating party issues a challenge specifying one or more check positions and expected mappings, the responding party generates recognition states according to the shared key context, and the authenticating party measures results and computes deltaR statistics. Authentication succeeds when deviation metrics satisfy a threshold condition and fails otherwise. In some embodiments, the system uses a rolling nonce or a session identifier to prevent replay.

In one embodiment, the RSQIE system supports a multi-tenant environment in which different tenants have different keys, key schedules, thresholds, and calibration contexts. In such embodiments, the system associates each session or stored record with a tenant identifier and a corresponding key management domain. The system enforces isolation by ensuring that keys and calibration contexts are not reused across tenants and by preventing cross-tenant decryption or verification access.

In one embodiment, the RSQIE system supports auditability and incident response. In one embodiment, the system logs events including session initiation, calibration updates, threshold changes, rekey events, verification failures, and detected anomalies. In some embodiments, logs include non-sensitive metadata sufficient for forensic analysis, such as timestamps, session identifiers, and aggregated verification statistics. Logs may be protected using integrity mechanisms and access controls.

In one embodiment, the RSQIE system supports performance tuning. For example, the system may tune K (window size), verification density, redundancy, and threshold parameters to meet application constraints. In a low-latency mode, the system may use smaller K and fewer check symbols. In a high-security mode, the system may use larger K, higher verification density, and more conservative thresholds. Parameter tuning may be performed at initialization, on-policy updates, or dynamically based on observed channel conditions.

In one embodiment, the RSQIE system supports interoperability across different quantum hardware backends by abstracting state preparation, encryption interaction, measurement, and estimation behind hardware interface layers. In one embodiment, a common RSQIE control layer computes recognition scalars, applies key schedule logic, manages framing, and enforces verification policy, while backend-specific drivers implement photonic, superconducting, trapped-ion, or continuous-variable operations. This abstraction permits deployment on available quantum hardware while maintaining consistent RSQIE logical behavior.

In one embodiment, the RSQIE system supports fail-safe behavior. In one embodiment, when verification metrics cannot be computed with sufficient confidence due to excessive loss, noise, or synchronization failure, the system defaults to a conservative policy, such as halting encrypted transmission, requesting re-calibration, requesting rekeying, or switching to a fallback secure mode.

In some embodiments, the fallback secure mode includes using post-quantum cryptography to secure critical communications while RSQIE conditions are re-established.

In one embodiment, the RSQIE system is configured such that its core security does not rely on integer factorization or discrete logarithms. As used herein, “quantum-resistant” refers to embodiments in which confidentiality and/or integrity do not depend on the assumed hardness of factorization or discrete logarithm problems, and instead depend on at least (i) a secret recognition key and associated key schedule that control a reversible recognition-coupled transformation applied to recognition-encoded quantum states and (ii) authorized endpoint reconstruction using the corresponding inverse transformation and decoding procedure. In disturbance-sensitive embodiments, additional security properties may arise from quantum-state behavior including the inability to universally clone unknown superposition states without disturbance, which can contribute to detectability of interception as described herein.

The disclosure herein provides enabling detail for multiple hardware embodiments, multiple mappings between recognition scalars and physical states, multiple encryption interaction realizations, multiple measurement and estimation procedures, and multiple verification and key management policies. Accordingly, the invention is not limited to any particular physical mapping, any particular modulation device, any particular quantum platform, any particular framing structure, or any particular threshold selection rule, and variations that maintain the disclosed recognition mapping, encryption/decryption reversibility, and verification logic remain within the scope of the appended claims.

Although specific embodiments and examples have been described, the scope of the invention is defined by the appended claims. The specification and drawings are to be regarded in an illustrative rather than restrictive sense, and all modifications that fall within the meaning and range of equivalency of the claims are intended to be embraced therein.

What is claimed is:

1. A quantum-resistant encryption method, comprising:
encoding digital information into quantum coherence recognition scalars according to a recognition mapping in which, for a symbol b associated with a positive parameter x_b, a recognition scalar R_b is computed as R_b=x_b/(x_b+X_opt), where X_opt is a predetermined constant;
preparing one or more quantum states representing the digital information based on the recognition scalars;
generating or provisioning a recognition key;
encrypting the one or more quantum states using an encryption transformation derived from a recognition-coupled interaction that depends on a message-associated recognition operator and a key-associated recognition operator;
transmitting or storing an encrypted representation corresponding to the encrypted one or more quantum states;
decrypting by applying an inverse transformation corresponding to the encryption transformation to recover one or more decrypted quantum states; and
reconstructing the digital information based on measurement of the one or more decrypted quantum states.

2. The method of claim 1, wherein the digital information comprises binary information encoded using a first recognition scalar R0 and a second recognition scalar R1 computed as R0=x0/(x0+X_opt) and R1=x1/(x1+X_opt), where x0 and x1 are positive values and x0 is not equal to x1.

3. The method of claim 1, wherein the encryption transformation is unitary and the inverse transformation reverses the encryption transformation such that decrypt(encrypt(m))=m for a message m in supported implementations.

4. The method of claim 1, further comprising verifying integrity by computing a coherence deviation deltaR=ABS(R_expected−R_measured), wherein R_expected is an expected recognition scalar and R_measured is an estimated recognition scalar obtained from measurement, and declaring a mismatch condition when a trigger condition is satisfied, wherein the trigger condition comprises at least one of: (i) deltaR>T_R for at least one verification position; (ii) deltaR_mean>T_R over a rolling window of length K, where deltaR_mean=(1/K)*Σ_{i=1 . . . K} ABS(R_expected(i)−R_measured(i)); or (iii) var_deltaR>T_var over the rolling window.

5. The method of claim 1, wherein the method is quantum-resistant in that confidentiality and/or integrity do not depend on integer factorization or discrete logarithms, and wherein the encrypting and decrypting depend on a secret recognition key and an associated key schedule that control the encryption transformation and the inverse transformation applied to the recognition-encoded quantum states.

6. The method of claim 1, further comprising providing disturbance-sensitive interception detection based on a constraint that unknown superposition states cannot be universally cloned without disturbance, including that a hypothetical universal cloning operation would require z\hat{ }2=z for overlap values z, and z\hat{ }2=z holds only for z in {0, 1}.

7. The method of claim 1, wherein the recognition key has length M over an alphabet of size A such that a key space cardinality is A\hat{ }M.

8. The method of claim 1, wherein X_opt is set to X_opt=phi/pi, where phi is the golden ratio and pi is the circular constant.

9. An encryption apparatus, comprising: one or more processors; one or more memories storing instructions that, when executed by the one or more processors, cause the apparatus to perform operations comprising: computing recognition scalars according to R_b=x_b/(x_b+X_opt) and preparing quantum states representing digital information based on the recognition scalars;
generating or provisioning a recognition key; encrypting the quantum states using an encryption transformation derived from a recognition-coupled interaction that depends on a message-associated recognition operator and a key-associated recognition operator; transmitting or storing an encrypted representation corresponding to the encrypted quantum states via an interface; decrypting using an inverse transformation corresponding to the encryption transformation; and reconstructing the digital information based on measurement of decrypted quantum states.

10. A security verification method, comprising: obtaining or determining an expected recognition scalar R_expected for one or more verification positions; estimating a measured recognition scalar R_measured for the one or more verification positions based on measurement outcomes; computing a coherence deviation deltaR=ABS(R_expected−R_measured); comparing deltaR, or a windowed statistic derived from deltaR, to one or more thresholds; and triggering a responsive action when a trigger condition is satisfied, wherein the trigger condition comprises at least one of: (i) deltaR>T_R for at least one verification position; (ii) deltaR_mean>T_R over a rolling window of length K, where deltaR_mean=(1/K)*Σ_{i=1 . . . K} ABS(R_expected(i)−R_measured(i)); or (iii) var_deltaR>T_var over the rolling window.

11. A non-transitory computer-readable medium storing instructions that, when executed by one or more processors, cause performance of operations comprising: computing recognition scalars according to R_b=x_b/(x_b+X_opt); preparing quantum states representing digital information based on the recognition scalars; generating or provisioning a recognition key; encrypting the quantum states using an encryption transformation derived from a recognition-coupled interaction;
decrypting using an inverse transformation corresponding to the encryption transformation;
reconstructing the digital information based on measurement; computing a coherence deviation deltaR=ABS(R_expected−R_measured) for verification; comparing deltaR, or a windowed statistic derived from deltaR, to one or more thresholds; and initiating a responsive action when a trigger condition is satisfied.

12. The method of claim 1, wherein a recognition frequency f_rec is computed as f_rec=v_eff/(X_opt*L_rec), where v_eff is an effective propagation velocity and L_rec is an effective recognition length, and wherein an interaction coupling constant g_crypto is computed as g_crypto=(hbar*v_eff)/(X_opt*L_rec).

13. The method of claim 10, wherein triggering the responsive action comprises initiating rekeying by generating new key material and switching to a new key schedule epoch.

14. The method of claim 1, wherein generating or provisioning the recognition key comprises establishing shared key material using a quantum key distribution procedure and deriving the recognition key from the shared key material.

15. The method of claim 1, wherein transmitting comprises transmitting the encrypted representation over at least one of an optical fiber link, a free-space optical link, or a satellite link.

16. The apparatus of claim 9, wherein the apparatus is implemented using at least one of superconducting qubits, trapped ions, quantum dots, or photon polarization states.

17. The method of claim 1, wherein the recognition mapping R_hat(x)=x/(x+X_opt) is bounded in an interval from 0 to 1 for x>0 and is strictly increasing for x>0.

18. The method of claim 1, wherein the method is applied to protect data stored in a cloud data center by encrypting stored data blocks as the digital information.

19. The method of claim 1, wherein the method is applied to authenticate an Internet-of-Things device using a recognition-based challenge-response that uses the recognition key.

20. The method of claim 1, wherein the method is applied to secure a banking transaction by encrypting transaction data as the digital information.
